(19) United States
(12) Patent Application Publication
(10) Pub. No.: US 2005/0253971 A1
(43) Pub. Date: Nov. 17, 2005

(54) Optical engine apparatus

(76) Inventor: Jin-sik Kim, Suwon-si (KR)

Correspondence Address: STANZIONE & KIM, LLP, 919 18TH STREET, N.W., SUITE 440, WASHINGTON, DC, 20006, US

(21) Appl. No.: 11/123,003

(22) Filed: May 6, 2005

(30) Foreign Application Priority Data
May 12, 2004 (KR) 2004-33630

(51) Int. Cl. H04N 5/64

(52) U.S. Cl. 348/744

(57) ABSTRACT

An optical engine apparatus magnifying and projecting an image beam formed by a display device on a screen, the optical engine apparatus including a light source having a bulb generating light and a reflection mirror reflecting the light provided adjacent to the bulb; and an optical filter inclinedly provided to reflect light components unnecessary for forming an image back to the light source, and to reflect the light components toward a lower portion of the reflection mirror which is positioned below the bulb. With this configuration, loss of light generated from a light source and projected to a display device is minimized, and brightness is improved. In addition, an optical path transformation unit is accommodated in an accommodation casing minimizing leaking of the light to thereby maintain good quality and protect from contamination due to dust or foreign substances.

### CROSS-REFERENCE TO RELATED APPLICATIONS

This application claims the benefit of Korean Patent Application No. 2004-33630 filed on May 12, 2004 in the Korean Intellectual Property Office, the disclosure of which is incorporated herein by reference.

### BACKGROUND OF THE INVENTION

1. Field of the Invention

The present general inventive concept relates to an optical engine, and more particularly, to an optical engine with an improved light source.

2. Description of the Related Art

An optical engine apparatus projects a light emitted from a light source toward a display device, such as a liquid crystal display (LCD) or a digital micro-mirror display (DMD), so as to form an image beam, and displays a picture by magnifying and projecting the image beam onto the screen.

As an example of the optical engine, a projector is disclosed in Korean Patent No. 0202548, the projector comprising a light source including a lamp and a reflection mirror; a ultra violet ray/infrared radiation (UV/IR) filter vertically aligned to the light source and cutting the ultra violet ray and the infrared radiation; and a projection lens projecting an image beam formed through the LCD on a screen.

However, as shown in FIG. 7, the UV/IR filter 140 of such a conventional projector is vertically aligned to the lengthwise direction of the light source, and thus the light emitted from a bulb 117 is reflected back to the light source together with unwanted ultra violet ray and infrared radiation by the UV/IR filter when the light is transmitted to the UV/IR filter 140. Herein, the unwanted ultra violet ray and infrared radiation reflected back to the light source by the UV/IR filter are converged at the bulb 114 causing damage to the bulb 117. Accordingly, the light source 116 incidently stops working, life expectancy of the light source 116 is shortened and its quality is degraded.

### SUMMARY OF THE INVENTION

Accordingly, it is an aspect of the present general inventive concept to provide an optical engine apparatus with a light source prevented from being damaged due to unwanted light so as to optimize quality of the light source while extending its life expectancy.

Additional aspects and/or advantages of the general inventive concept will be set forth in part in the description which follows and, in part, will be obvious from the description, or may be learned by practice of the general inventive concept.

The foregoing and/or other aspects and advantages of the present general inventive concept are achieved by providing an optical engine apparatus magnifying and projecting an image beam formed by a display device on a screen, the optical engine apparatus comprising a light source comprising: a bulb generating light and a reflection mirror reflecting the light provided adjacent to the bulb; and an optical filter inclinedly provided so as to reflect light components unnecessary for forming an image back to the light source, and to reflect the light components toward a lower portion of the reflection mirror which is positioned below the bulb.

According to an embodiment of the present general inventive concept, the optical filter is inclinedly disposed with respect to a traveling line of the light from the light source so that an upper portion of the optical filter is inclined toward the light source and a lower portion of the optical filter is inclined away from the light source.

According to an embodiment of the present general inventive concept, the optical filter is inclined leftward or rightward with respect to the traveling line of the light from the light source while the upper portion thereof is inclined toward the light source and the lower portion thereof is inclined away from the light source.

According to an embodiment of the present general inventive concept, the optical filter cuts at least one of ultra violet rays and infrared radiation in the light emitted from the light source.

According to an embodiment of the present general inventive concept, the optical engine apparatus further comprises a color wheel assembly to which the light passed through the optical filter is transmitted, and the optical filter is inclinedly coupled to a side of the color wheel assembly.

According to an embodiment of the present general inventive concept, the color wheel assembly comprises an optical filter mounting part provided in a side of the color wheel assembly, and accommodating the optical filter to be inclined at a given angle; and an optical filter supporting bracket coupled to the optical filter mounting part and supporting the optical filter accommodated at the optical filter mounting part.

The foregoing and other aspects and advantages of the present general inventive concept are also achieved by providing an optical engine apparatus magnifying and projecting an image beam formed by a display device on a screen, the optical engine apparatus comprising: a light source emitting light; and an optical filter inclined leftward or rightward with respect to a traveling line of the light from the light source, and cutting off the light components in the light emitted from the light source.

According to an embodiment of the present general inventive concept, the optical filter cuts at least one of ultra violet rays and infrared radiation in the light emitted from the light source.

### BRIEF DESCRIPTION OF THE DRAWINGS

These and/or other aspects and advantages of the present general inventive concept will become apparent and more readily appreciated from the following description of the embodiments, taken in conjunction with the accompany drawings of which:

FIG. 1 is a combined perspective view of an optical engine apparatus according to an embodiment of the present general inventive concept;

FIG. 2 is an exploded perspective view of the optical engine apparatus in FIG. 1;

FIG. 3 is an exploded perspective view of a color wheel assembly and a UV cut filter in FIG. 2;

FIG. 4 is a combined perspective view of the color wheel assembly and the UV cut filter in FIG. 2;

FIG. 5 is a schematic view of a light source and the UV cut filter;

FIG. 6 is an exploded perspective view of a color wheel and a UV cut filter according to another embodiment of the present general inventive concept; and

FIG. 7 is a schematic view of a light source and a UV cut filter according to a conventional optical engine apparatus.

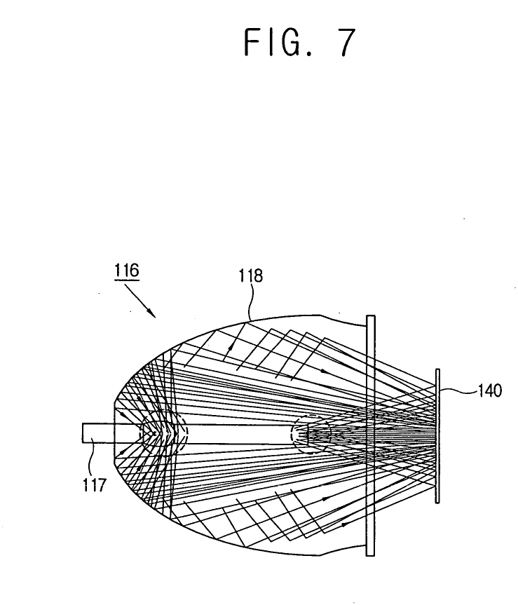

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

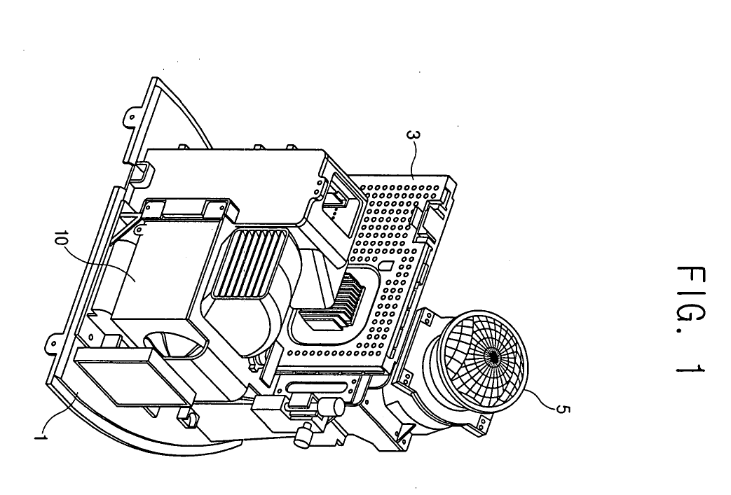

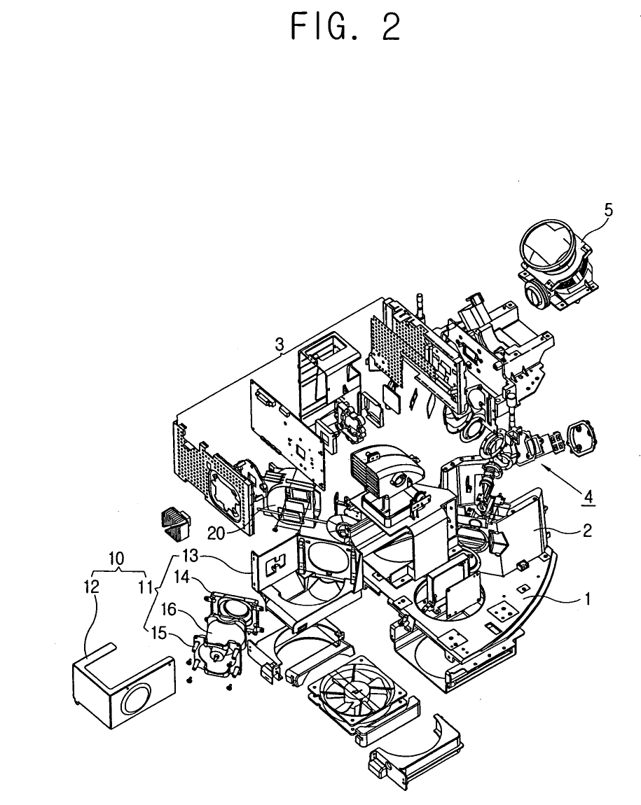

As shown in FIGS. 1 and 2, an optical engine device may include a light source 10 generating light; a DMD panel 3 used as a display device on which the light emitted from the light source 10 is projected to form an image beam; and a projector 5 magnifying and projecting the image beam generated by the display device 3 to a screen of a projection television.

Here, the light source 10 is seated on a base 1, and an optical unit accommodation casing 2 is placed behind the light source 10 and coupled to the base 2. The optical unit accommodation casing 2 accommodates various optical engine components such as a color wheel assembly 20 having a color wheel selectively sorting the light from the light source 10 by light of red (R), green (G) and blue (B), an illuminator 4 uniformizing the light passed through the color wheel assembly 20 and transforming a path of the uniformized light toward the display device 3, and so on.

The light source 10 may include a lamp assembly 11 emitting light and a lamp assembly cover 12 covering the lamp assembly 11. The lamp assembly 11 may include a lamp main body 16 generating the light; a first and a second lamp supporters 14 and 15 respectively placed in front and behind the lamp main body 16 and supportably coupled to the lamp main body 16; and a lamp support housing 13 supportably seating the first and the second lamp supporters 14 and 15 and the lamp main body 16 to which the first and the second lamp supporters 14 and 15 are coupled on the base 1.

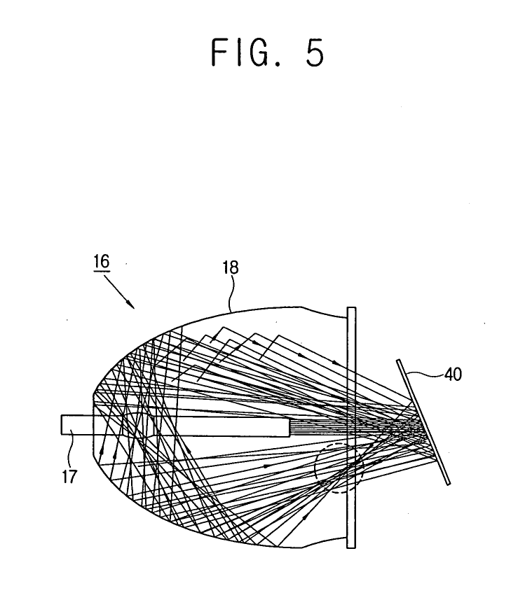

The lamp main body 16 may include a bulb 17 (see FIG. 5) as a light source generating light; and a reflection mirror 18 reflecting the light from the bulb 17 to guide a traveling path of the light.

The bulb 17 may be replaced with an arc discharge lamp such as a mercury lamp, a metal halide lamp and a xenon lamp, etc.

The reflection mirror 18 is hemispherically shaped, and coupled to the bulb 17 by surrounding it while leaving a front portion of the reflection mirror 18 opened so that the light from the bulb 17 can be passed therethrough and transmitted to a UV cut filter 40 (to be described later). The reflection mirror 18 may be shaped like an oval having a position of the bulb 17 as a first focus point and another position to which the light is focused as a second focus point, or may be a parabolic reflection mirror having a position of the bulb 17 as the first focus point so that the light emitted from the bulb 17 can be parallelly reflected.

Meanwhile, the bulb 17 of the lamp main body 16 emits unwanted ultra violet (UV) rays and infrared radiation (IR), which are useless to form an image, and the ultra violet rays are cut by an IR protection filter coated over an inner surface of the reflection mirror 18, and the infrared radiation is cut by an optical UV cut filter 40.

In other words, the UN cut filter 40 is provided in a path between the light source 10 and the color wheel assembly 20, and filters the light from the light source 10 allowing visible rays to be passed therethrough while reflecting the ultra violet rays back to the lamp main body 16.

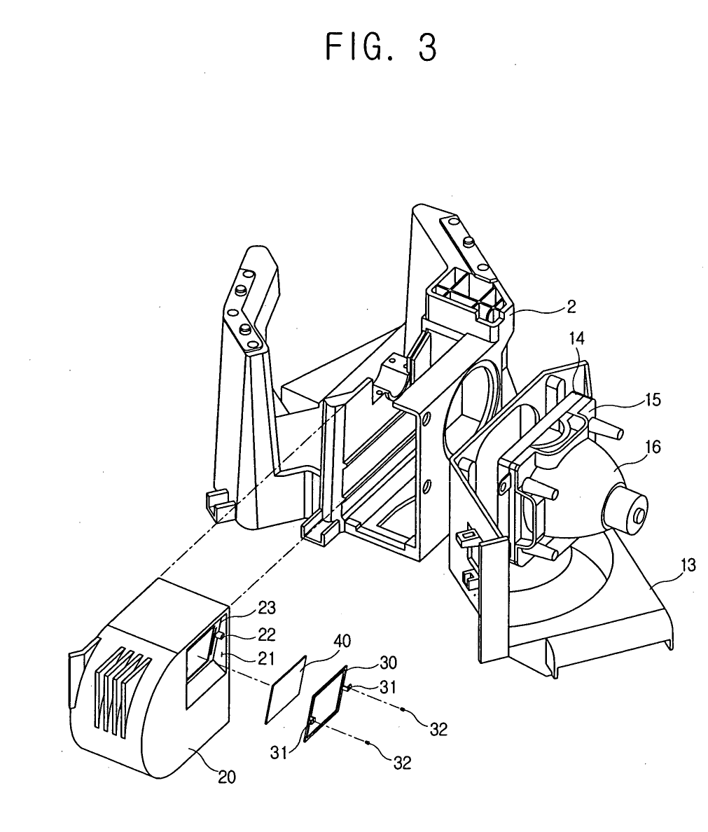

As illustrated in FIG. 3, the optical UV cut filter 40 is inclinedly coupled to an optical filter mounting part 21 provided to a side of the color wheel assembly 20, and supported by an optical filter supporting bracket 30 coupled to the color wheel assembly 20.

The optical UV cut filter 40 protects the color wheel from damage by filtering the light from the bulb 17 so as to allow the visible rays to be transmitted to the color wheel, and reflects the UV rays back to the reflection mirror 18 of the lamp main body 16.

As illustrated in FIG. 3, the optical filter mounting part 21 provided on the side of the color wheel assembly 20, as well as the side itself, has an inclined surface 23 sunken and inclined at a given angel. The inclined surface 23 is inclined downward (or upward) so that the UV cut filter 40, coupled to the optical filter mounting part 21 and cohered to the inclined surface 23, can project the ultra violet rays reflected by the UV cut filter 40 to a lower portion of the reflection mirror 18, as shown in FIG. 5. In other words, an upper portion of the UV cut filter 40 is inclined toward the light source 10 and the lower portion of the UV cut filter 40 is inclined away from the light source 10. Although the UV cut filter 40 is inclined downward (or upward) as shown in FIG. 5, the UV cut filter 40 may be inclined to a left or right direction with respect to a traveling line of the light from the light source 10 while being inclined downward (or upward).

The optical filter supporting bracket 30 is placed in front of the UV cut filter 40 and coupled to the optical filter mounting part 21 by coupling members 22, 31 and 32 to support the UV cut filter 40 accommodated at the optical filter mounting part 21.

The coupling members 22, 31 and 32 comprise a coupling boss 22 having a screw head and provided in the optical filter mounting part 21; a coupling hole 31 formed penetrating through the optical filter supporting bracket at a position corresponding to the coupling boss 22; and a screw 32 coupled to the coupling boss 22 through the coupling hole 31 and screwing the optical filter supporting bracket 30 to the optical filter mounting part 40.

In the optical engine apparatus with the foregoing configuration, the UV cut filter 40 is installed at a side of the color wheel assembly 20 following a method described hereinafter.

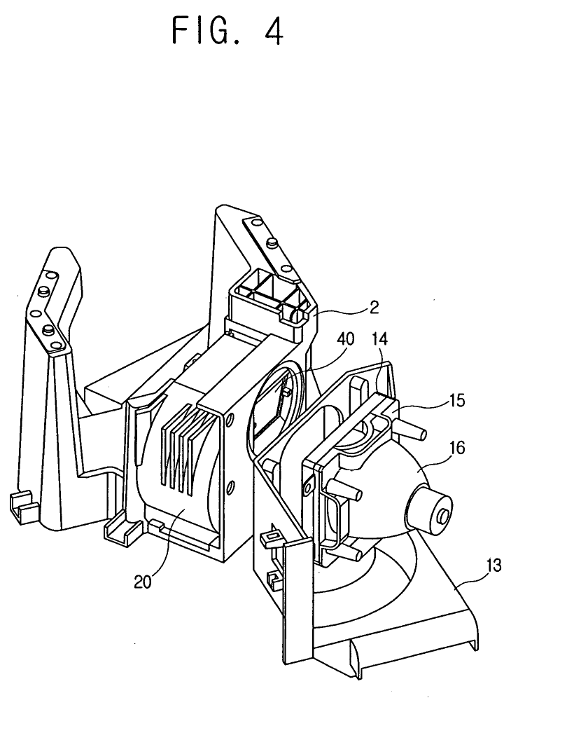

First, as illustrated in FIGS. 3 and 4, the UV cut filter 40 is mounted to the optical filter mounting part 21 formed in the side of the color wheel assembly 20. Here, the UV cut filter 40 is accommodated at the inclined surface 23 of the optical filter mounting part 21 so as to be inclined downward (or upward) due to the inclined surface 23, which is also inclined downward (or upward). The optical filter supporting bracket 30 is screwed to the optical filter mounting part 21 by using the coupling members 22, 31 and 32 to place the optical filter supporting bracket 30 in front of the UV filter mounting part 21. In other words, the coupling holes 31 of the optical filter supporting bracket 30 are provided to communicate with the coupling boss 22 of the optical filter mounting part 21, and each screw 32 is inserted into the respective coupling hole 32 to screw the optical filter supporting bracket 30 to the coupling boss 22.

As shown in FIG. 5, if the UV cut filter 40 is inclined downward (or upward), the visible ray in the light emitted from the bulb 17 of the light source 10 are passed through the UV cut filter 40 and transmitted to the color wheel, and the IR is blocked by the IR protection filter coated over the inner surface of the reflection mirror 18, and reflected to the reflection mirror 18 by the UV cut filter 40. Herein, the UV cut filter 40 inclined downward (or upward) and thus the UV rays reflected back to the reflection mirror 18, are not converged onto the bulb 17, but converged at a lower portion of the reflection mirror 18 centering on the bulb 17. Therefore, temperature in the lower portion of the reflection mirror 18 is balanced to the temperature in an upper portion of the reflection mirror 18 which is heated to a relatively high temperature. Accordingly, the balanced temperature distribution between the upper and the lower portions of the reflection mirror 18 preserves the light source 10 in a stable condition, thereby enhancing quality and extending life expectancy of the light source 10. Further, as described the above, the UV rays are not converged onto the bulb 17, and thus the bulb 17 does not incidently stop working due the converged UV rays.

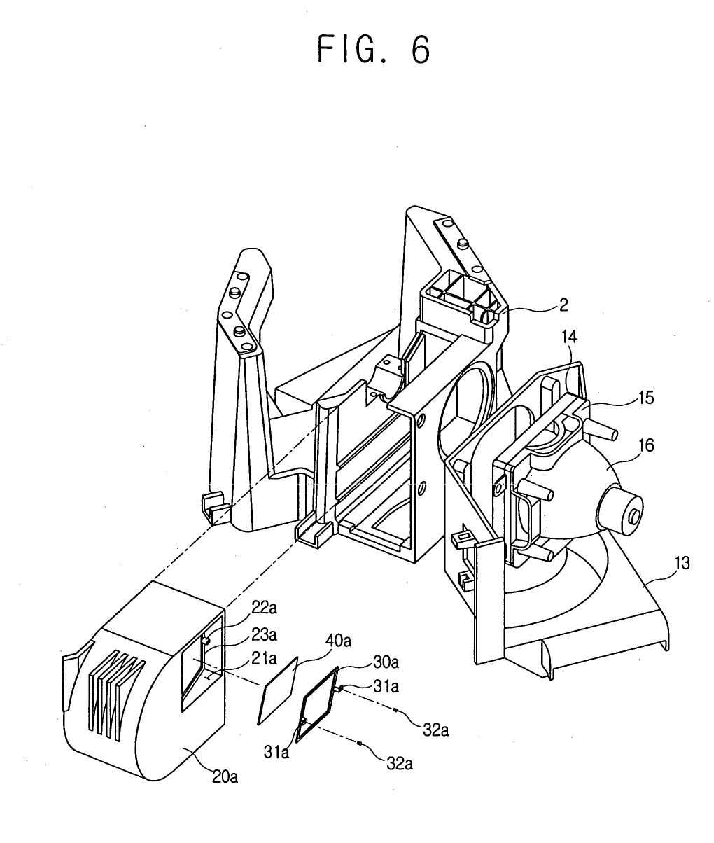

Meanwhile, according to the foregoing embodiment, the UV cut filter 40 is inclined downward (or upward), but it may be inclined leftward or rightward, as shown in FIG. 6. Hereinafter, repeated descriptions related to the foregoing embodiment and its configurational aspects will be skipped.

As shown in FIG. 6, on a side of a color wheel assembly 20a is formed an optical filter mounting part 21a inclined leftward or rightward, and a UV cut filter 40a is mounted therein. In more detail, an optical filter supporting bracket 30a placed in front of the optical filter mounting part 21a is coupled to the optical filter mounting part 21a by coupling members comprising a coupling boss 22a provided in the optical filter mounting part 21a and having a screw head; a coupling hole 31a formed in the optical filter supporting bracket 30a with respect to the coupling boss 22a; and a screw 32a screwed to the coupling boss 22 to couple the optical filter supporting bracket 30a to the optical filter mounting part 21a.

If the UV cut filter 40a adhered to the inclined surface of the optical filter mounting part 21a and inclined leftward or rightward while being coupled to the optical filter supporting bracket 30a, the UV ray is reflected back to the reflection mirror 18 by the UV cut filter 40a. Herein, the reflected UV rays are not converged onto the bulb 17 but converged onto a portion in the reflection mirror 18, which is separated from the bulb 17, and thereby preventing the bulb 17 from being damaged due to the converged UV ray.

According to the embodiments, the UV cut filter 40 is inclined downward (or upward), or leftward (or rightward), but not limited thereto. The UV cut filter may be inclined toward various directions as long as the UV ray is not converged onto the bulb when the UV cut filter reflects the UV ray back to the reflection mirror.

Further, according to the embodiments, the UV rays are cut by the IR protecting filter formed inside the reflection mirror, and the optical filter may be replaced with the UV cut filter cutting the UV ray only, a UV/IR cut filter cutting both of the UV ray and IR both, or an IR cut filter cutting the IR.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An optical engine apparatus magnifying and projecting an image beam formed by a display device on a screen, the optical engine apparatus comprising:
a light source comprising a bulb generating light and a reflection mirror reflecting the light provided adjacent to the bulb; and
an optical filter inclinedly provided to reflect light components unnecessary for forming an image back to the light source, and to reflect the light components toward a lower portion of the reflection mirror which is positioned below the bulb.

2. The optical engine apparatus according to claim 1, wherein the optical filter is inclinedly disposed with respect to a traveling line of the light from the light source so that an upper portion of the optical filter is inclined toward the light source and a lower portion of the optical filter is inclined away from the light source.

3. The optical engine apparatus according to claim 2, wherein the optical filter is inclined leftward or rightward with respect to the traveling line of the light from the light source while the upper portion thereof is inclined toward the light source and the lower portion thereof is inclined away from the light source.

4. The optical engine apparatus according to claim 2, wherein the optical filter cuts at least one of ultra violet rays and infrared radiation in the light emitted from the light source.

5. The optical engine apparatus according to claim 4, further comprising a color wheel assembly to which the light passed through the optical filter is transmitted, and the optical filter is inclinedly coupled to a side of the color wheel assembly.

6. The optical engine apparatus according to claim 5, wherein the color wheel assembly comprises:
an optical filter mounting part provided in a side of the color wheel assembly and accommodating the optical filter to be inclined at a given angle; and
an optical filter supporting bracket coupled to the optical filter mounting part and supporting the optical filter accommodated to the optical filter mounting part.

7. An optical engine apparatus magnifying and projecting an image beam formed by a display device on a screen, the optical engine apparatus comprising:
a light source emitting light; and
an optical filter inclined leftward or rightward with respect to a traveling line of the light from the light source and cutting off the light components in the light emitted from the light source.

8. The optical engine apparatus according to claim 7, wherein the optical filter cuts at least one of ultra violet rays and infrared radiation in the light emitted from the light source.

9. The optical engine apparatus according to claim 8, further comprising a color wheel assembly to which the light passed through the optical filter is transmitted and the optical filter is inclinedly coupled to a side of the color wheel assembly.

10. The optical engine apparatus according to claim 9, wherein the color wheel assembly comprises:
an optical filter mounting part provided in a side of the color wheel assembly and accommodating the optical filter to be inclined at a given angle; and
an optical filter supporting bracket coupled to the optical filter mounting part and supporting the optical filter accommodated to the optical filter mounting part.

11. An optical engine apparatus magnifying and projecting an image beam formed by a display device on a screen, the optical engine apparatus comprising:
a light source including a bulb generating light and a reflection device reflecting the light provided adjacent to the bulb; and
an optical filter tilted at a predetermined angle to reflect light components unnecessary for forming an image back to the light source, and to reflect the light components toward a portion of the reflection device positioned adjacent to the bulb.

12. The optical engine apparatus according to claim 11, wherein the optical filter is disposed with respect to a traveling line of the light from the light source so that a first side of the optical filter is inclined toward the light source and a second side of the optical filter opposite to the first side is inclined away from the light source.

13. The optical engine apparatus according to claim 12, wherein the optical filter cuts at least one of ultra violet rays and infrared radiation in the light emitted from the light source.

14. The optical engine apparatus according to claim 13, further comprising a color wheel assembly to which the light passed through the optical filter is transmitted and the optical filter is coupled to a side of the color wheel assembly at an angle of inclination.

15. The optical engine apparatus according to claim 14, wherein the color wheel assembly comprises:
an optical filter mounting part provided in a side of the color wheel assembly and accommodating the optical filter to be tilted at the predetermined angle; and
an optical filter supporting bracket coupled to the optical filter mounting part and supporting the optical filter accommodated at the optical filter mounting part.
